(19) United States
(12) Patent Application Publication
(10) Pub. No.: US 2015/0163215 A1
(43) Pub. Date: Jun. 11, 2015

(54) Method and Apparatus for Upgrading Open Authentication (OAUTH) Credentials

(71) Applicant: TENCENT TECHNOLOGY (SHENZHEN) COMPANY LIMITED, Shenzhen (CN)

(72) Inventor: Jiangwei Qin, Shenzhen (CN)

(21) Appl. No.: 14/623,676

(22) Filed: Feb. 17, 2015

Related U.S. Application Data
(63) Continuation of application No. PCT/CN2013/088116, filed on Nov. 29, 2013.

(30) Foreign Application Priority Data
Apr. 17, 2013 (CN) 201310133127.6

(51) Int. Cl. H04L 29/06

(52) U.S. Cl. CPC H04L 63/08

(57) ABSTRACT

According to an example, after the open platform upgrades its OAuth protocol version, if receiving a service request carrying an old version OAuth credential, the open platform prompts the third party application to upgrade its OAuth credential. The third party application starts the OAuth credential upgrade process initiatively by transmitting a version upgrade request to the open platform.

### CROSS-REFERENCE TO RELATED APPLICATIONS

This application is a continuation of International Application No. PCT/CN2013/088116, filed on Nov. 29, 2013. This application claims the benefit and priority of Chinese Patent Application No. 201310133127.6, filed Apr. 17, 2013. The entire disclosures of each of the above applications are incorporated herein by reference.

### FIELD

The present disclosure relates to open authentication (OAuth) protocol techniques, and more particularly, to a method and an apparatus for upgrading an OAuth credential.

### BACKGROUND

OAuth is an open standard for authorization. It allows users to share their private resources (e.g. photos, videos, contact lists) stored on one site with another site without having to hand out their credentials, typically username and password.

OAuth allows users to hand out tokens instead of credentials to their data hosted by a given service provider. Each token grants access to a specific site (e.g. a video editing site) for specific resources (e.g. just videos from a specific album) and for a defined duration (e.g. the next 2 hours). This allows a user to grant a third party site access to their information stored with another service provider, without sharing their access permissions or the full extent of their data.

Currently, there are three versions of OAuth protocols, i.e., OAuth 1.0, OAuth 1.a and OAuth 2.0.

The OAuth 2.0 protocol is not backward compatible with OAuth 1.0. The two versions may co-exist on the network, and implementations may choose to support both.

### SUMMARY

According to an example of the present disclosure, a method for upgrading an OAuth credential is provided. The method includes:
receiving, by an open platform, a service request from a third party application requesting a service from the open platform, wherein the service request carries an OAuth credential representing an authorization granted to the third party application by a resource owner;
determining, by the open platform, whether the OAuth credential carried in the service request is of an old version OAuth protocol; prompting, by the open platform, the third party application to perform a version upgrade operation if the OAuth credential carried in the service calling request is of the old version OAuth protocol;
receiving, by the open platform, a version upgrade request from the third application, wherein the version upgrade request carries an identifier of the third party application, an identifier of the resource owner and the old version OAuth credential;
validating, by the open platform, the old version OAuth credential carried in the version upgrade request; issuing, by the open platform, a new version OAuth credential to the third party application if the old version OAuth credential is valid; and
returning, by the open platform, the new version OAuth credential to the third party application.

According to another example of the present disclosure, a method for upgrading an OAuth credential is provided. The method includes:
transmitting, by a third party application, a service request to an open platform requesting a service from the open platform, wherein the service request carries an OAuth credential representing an authorization granted to the third party application by a resource owner;
receiving, by the third party application, from the open platform prompt information indicating that the OAuth credential carried in the service request is of an old version OAuth protocol;
transmitting, by the third party application, a version upgrading request to the open platform, such that the open platform issues a new version OAuth credential to the third party application; wherein the version upgrade request carries an identifier of the third party application, an identifier of the resource owner and the old version OAuth credential; and
receiving, by the third party application, the new version OAuth credential issued by the open platform.

According to another example of the present disclosure, a non-transitory computer-readable storage medium comprising a set of instructions for upgrading an OAuth credential is provided, the set of instructions to direct at least one processor to perform acts of:
receiving a service request from a third party application requesting a service from the open platform, wherein the service request carries an OAuth credential representing an authorization granted to the third party application by a resource owner;
determining whether the OAuth credential carried in the service request is of an old version OAuth protocol; prompting, by the open platform, the third party application to perform a version upgrade operation if the OAuth credential carried in the service calling request is of the old version OAuth protocol;
receiving a version upgrade request from the third application, wherein the version upgrade request carries an identifier of the third party application, an identifier of the resource owner and the old version OAuth credential;
validating the old version OAuth credential carried in the version upgrade request; issuing, by the open platform, a new version OAuth credential to the third party application if the old version OAuth credential is valid; and
returning the new version OAuth credential to the third party application.

Other aspects or embodiments of the present disclosure can be understood by those skilled in the art in light of the description, the claims, and the drawings of the present disclosure.

### BRIEF DESCRIPTION OF THE DRAWINGS

Features of the present disclosure are illustrated by way of example and not limited in the following figures, in which like numerals indicate like elements, in which:

FIG. 1 is a schematic diagram illustrating an example of a computer system for executing the method of the present disclosure.

FIG. 2 is a flowchart illustrating a method for upgrading an OAuth credential at an open platform side according to an example of the present disclosure.

FIG. 3 is a flowchart illustrating a method for upgrading an OAuth credential at a third party application side according to an example of the present disclosure.

FIG. 4 is a schematic diagram illustrating a method for upgrading an OAuth credential according to another example of the present disclosure.

FIG. 5 is schematic diagram illustrating an open platform for upgrading an OAuth credential according to an example of the present disclosure.

FIG. 6 is a schematic diagram illustrating a third party application for upgrading an OAuth credential according to an example of the present disclosure.

### DETAILED DESCRIPTION

The preset disclosure will be described in further detail hereinafter with reference to accompanying drawings and examples to make the technical solution and merits therein clearer.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

In conventional techniques, after an open platform upgrades its OAuth protocol version (e.g., from OAuth 1.0 to OAuth 2.0), a third party application may need to upgrade to OAuth 2.0 from OAuth 1.0. In a conventional upgrade procedure, since the OAuth 2.0 protocol is not backward compatible with OAuth 1.0, all OAuth 1.0 credentials authorized by users (resource owners) will be revoked. If the third party needs to call an API interface of the open platform, the resource owner has to perform an OAuth 2.0 authorization to the third party application. Thus, services of the third party application are interrupted.

In various examples of the present disclosure, after an open platform upgrades its OAuth protocol version, the third party application starts the OAuth credential upgrade process initiatively when requesting services from the open platform. The open platform issues a new version OAuth credential to the third party application. Thus, interruption of the service of the third party application can be avoided.

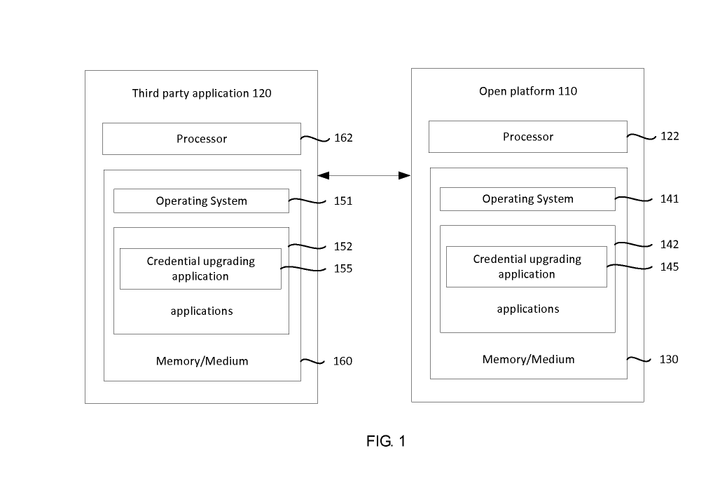

FIG. 1 is a schematic diagram illustrating an example of a computer system which may execute the method of the present disclosure. As shown in FIG. 1, the computer system includes an open platform 110 and a third party application 120.

The open platform 110 may issue credentials (e.g., access tokens) to the third party application 120 after successfully authenticating a resource owner and obtaining authorization. The resource owner is an entity capable of granting access to a protected resource. When the resource owner is a person, it is referred to as an end-user. The open platform 110 may further host protected resources, capable of accepting and responding to protected resource requests using access tokens.

The open platform 110 in FIG. 1 represents one or more electronic devices, such as one or more computers, that is made available to the third party application 120 via, e.g., the Internet. Various hardware components (not shown in FIG. 1) such as external monitors, keyboards, mice, hard disk drives, and other devices may be used in conjunction with open platform 110. For example, the open platform 110 may include a variety of operating systems 141 and a variety of possible applications 142, such as a credential upgrading application 145.

Further, the open platform 110 may include one or more non-transitory processor-readable storage media 130 and one or more processors 122 in communication with the non-transitory processor-readable storage media 130.

The third party application 120 makes protected resource requests on behalf of the resource owner and with its authorization. It may also be referred to as a client. The term “client” does not imply any particular implementation characteristics (e.g., whether the application executes on a server, a desktop, or other devices). The third party application 120 may be an electronic device, such as a desktop computer. It executes a variety of possible applications 152, such as a credential upgrading application 155.

The third party application 120 may include one or more non-transitory processor-readable storage media 160 and one or more processors 162 in communication with the non-transitory processor-readable storage media 160.

In examples of the present disclosure, the non-transitory processor-readable storage media 130 and 160 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage media 130 and 160 may store sets of instructions, or units and/or modules that include the sets of instructions, for conducting operations described in the present disclosure. The one or more processors may be configured to execute the sets of instructions and perform the operations in examples of the present disclosure.

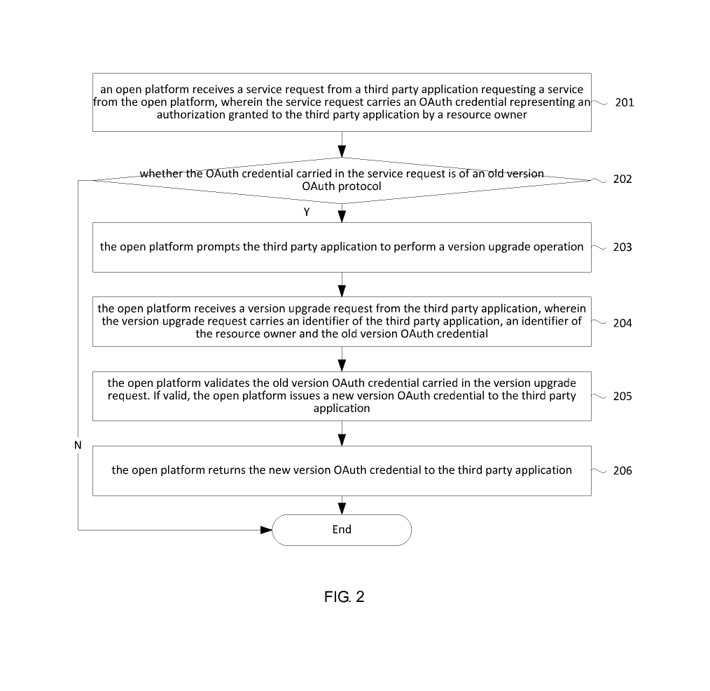

FIG. 2 is a schematic diagram illustrating a method for upgrading an OAuth credential at an open platform side according to an example of the present disclosure. FIG. 2 is a simplified diagram according to one embodiment of the present invention. This diagram is merely an example, which should not unduly limit the scope of the claims. One of ordinary skill in the art would recognize many variations, alternatives, and modifications.

As shown in FIG. 2, the method includes the following processes.

At block 201, an open platform receives a service request from a third party application requesting a service (e.g., a protected resource) from the open platform, wherein the service request carries an OAuth credential representing an authorization granted to the third party application by a resource owner.

In this example, the OAuth credential may be an access token defined by the OAuth protocol.

At block 202, the open platform determines whether the OAuth credential carried in the service request is of an old version OAuth protocol, if yes, block 203 is performed; otherwise, the method ends.

At block 203, the open platform prompts the third party application to perform a version upgrade operation.

In this block, the open platform may return an error code to the third party application, indicating that the OAuth credential transmitted by the third party application is of an old version OAuth protocol. Thus, after receiving the error code, the third party application knows that its OAuth credential is of the old version OAuth protocol, and then initiates a version upgrade operation.

At block 204, the open platform receives a version upgrade request from the third party application, wherein the version upgrade request carries an identifier of the third party application, an identifier of the resource owner and the old version OAuth credential.

At block 205, the open platform validates the old version OAuth credential carried in the version upgrade request. If valid, the open platform issues a new version OAuth credential to the third party application.

After issuing the new version OAuth credential to the third party application, the open platform establishes a relationship which associates the new version OAuth credential, the identifier of the resource owner and the identifier of the third party application. The open platform stores the relationship and revokes the old version OAuth credential.

At block 206, the open platform returns the new version OAuth credential to the third party application.

After receiving the new version OAuth credential, the third party application binds the new version OAuth credential and the user identifier and records a binding relationship.

Thereafter, the third party application may transmit a new service request carrying the new version OAuth credential to the open platform.

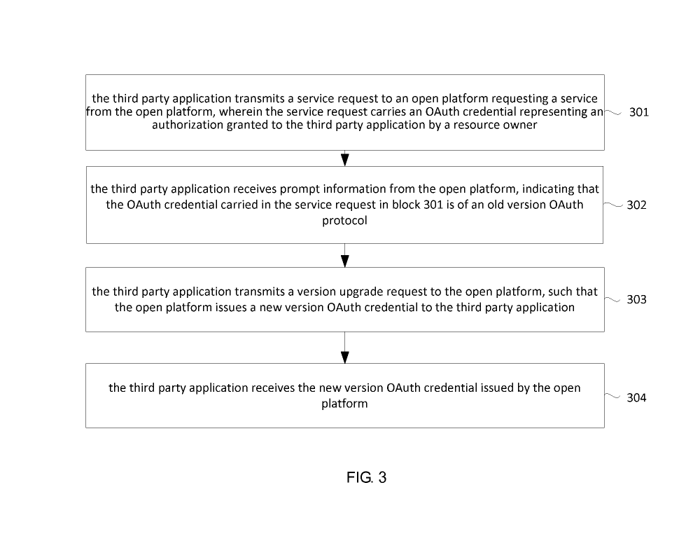

FIG. 3 is a schematic diagram illustrating a method for upgrading an OAuth credential at a third party application side according to an example of the present disclosure. FIG. 3 is a simplified diagram according to one embodiment of the present invention. This diagram is merely an example, which should not unduly limit the scope of the claims. One of ordinary skill in the art would recognize many variations, alternatives, and modifications.

As shown in FIG. 3, the method includes the following processing.

At block 301, the third party application transmits a service request to an open platform requesting a service (e.g., a protected resource) from the open platform, wherein the service request carries an OAuth credential representing an authorization granted to the third party application by a resource owner.

In this example, the OAuth credential may be an access token defined by the OAuth protocol.

At block 302, the third party application receives prompt information from the open platform, indicating that the OAuth credential carried in the service request in block 301 is of an old version OAuth protocol.

In this block, the prompt information may be an error code. After receiving the error code, the third party application knows that its OAuth credential is of the old version OAuth protocol, and then initiates a version upgrade operation.

At block 303, the third party application transmits a version upgrade request to the open platform, such that the open platform issues a new version OAuth credential to the third party application; wherein the version upgrade request carries an identifier of the third party application, an identifier of the resource owner and the old version OAuth credential.

At block 304, the third party application receives the new version OAuth credential issued by the open platform.

After receiving the new version OAuth credential, the third party application may bind the new version OAuth credential and the identifier of the resource owner and record a binding relationship.

Thereafter, the third party application may transmit a new service request carrying the new version OAuth credential to the open platform.

According to the above examples, after the open platform upgrades its OAuth protocol version, if receiving a service request carrying an old version OAuth credential, the open platform may prompt the third party application to upgrade its OAuth credential. Thus, the third party application may start the OAuth credential upgrade process initiatively by transmitting a version upgrade request to the open platform. The open platform issues a new version OAuth credential to the third party application. Thus, the OAuth credential can be upgraded smoothly and interruption of the service of the third party application can be avoided.

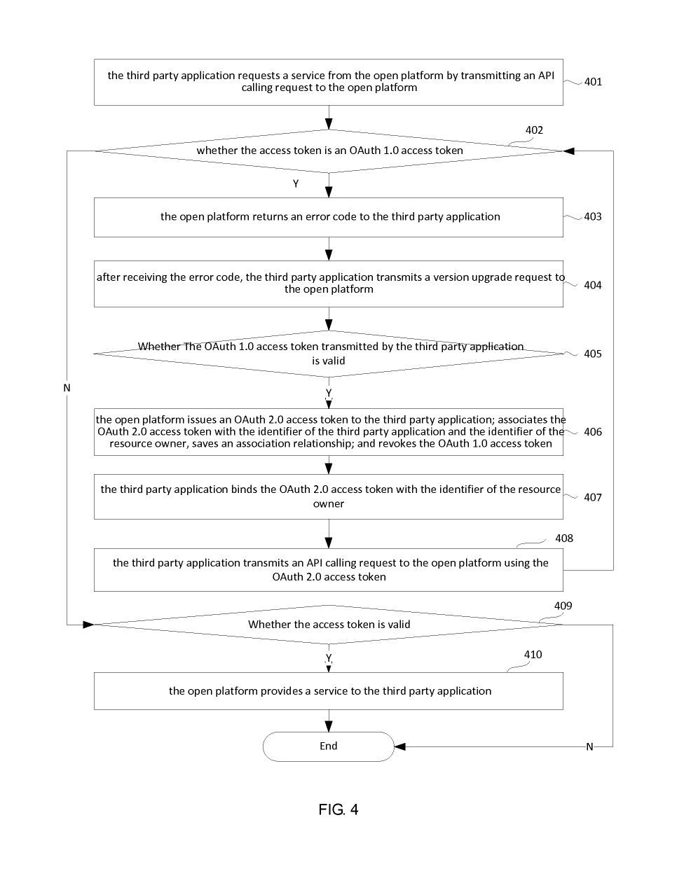

FIG. 4 is a flowchart illustrating a method for upgrading an OAuth credential according to another example of the present disclosure. In this example, the old version OAuth credential is an OAuth 1.0 access token, and the new version OAuth credential is an OAuth 2.0 access token. The third party application requests a service from the open platform by calling an application programming interface (API). FIG. 4 is a simplified diagram according to one embodiment of the present invention. This diagram is merely an example, which should not unduly limit the scope of the claims. One of ordinary skill in the art would recognize many variations, alternatives, and modifications.

As shown in FIG. 4, the method includes the following.

At block 401, the third party application requests a service from the open platform by transmitting an API calling request to the open platform; wherein the API calling request carries an OAuth credential representing an authorization granted to the third party application by a resource owner.

At block 402, the open platform determines whether the access token is an OAuth 1.0 access token. If the access token is an OAuth 1.0 access token, block 403 is performed; otherwise, block 409 is performed.

At block 403, the open platform returns an error code to the third party application, so as to prompt the third party application to perform a version upgrade operation.

At block 404, after receiving the error code, the third party application transmits a version upgrade request to the open platform, wherein the version upgrade request includes an identifier of the third party application, the OAuth 1.0 access token, and an identifier of the resource owner.

At block 405, after receiving the version upgrade request, the open platform validates the OAuth 1.0 access token transmitted by the third party application according to an OAuth 1.0 authentication manner. If valid, block 406 is performed.

At block 406, the open platform issues an OAuth 2.0 access token to the third party application; associates the OAuth 2.0 access token with the identifier of the third party application and the identifier of the resource owner, saves an association relationship; and revokes the OAuth 1.0 access token.

At block 407, after receiving the OAuth 2.0 access token newly issued, the third party application binds the OAuth 2.0 access token with the identifier of the resource owner.

At block 408, the third party application transmits an API calling request to the open platform using the OAuth 2.0 access token and the method returns to block 402.

At block 409, the open platform validates the access token. If valid, block 410 is performed; otherwise, the method ends.

At block 410, the open platform provides a service to the third party application.

According to the above example, after the open platform upgrades its OAuth protocol version, if receiving a service request carrying an old version OAuth credential, the open platform may prompt the third party application to upgrade its OAuth credential. Thus, the third party application may start the OAuth credential upgrade process initiatively by transmitting a version upgrade request to the open platform. The open platform issues a new version OAuth credential to the third party application. Thus, the OAuth credential can be upgraded smoothly and interruption of the service of the third party application can be avoided.

Now, the method provided by the examples of the present disclosure has been described. In accordance with the above method examples, the present disclosure also provides an open platform and a third party application for executing the above method examples.

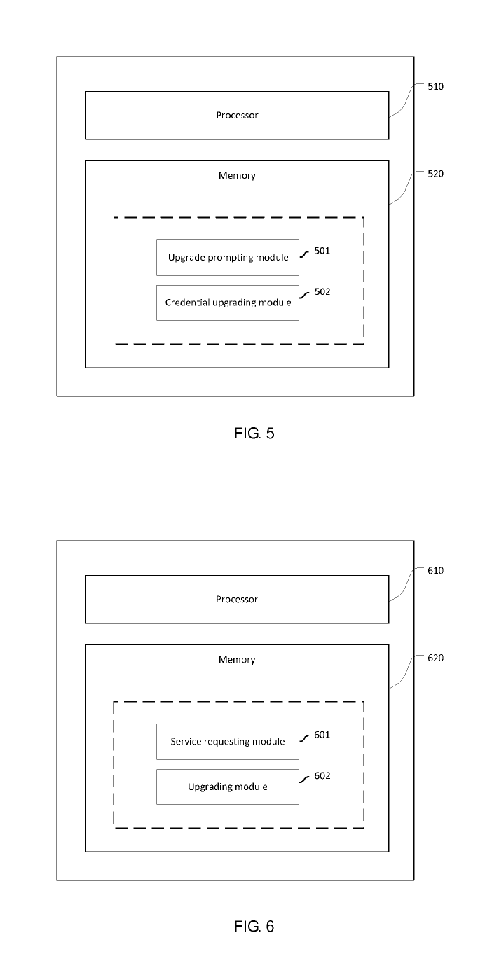

According to an example of the present disclosure, an open platform for upgrading an OAuth credential is provided. As shown in FIG. 5, the open platform 500 includes:
one or more processors 510;
a memory 520; and
one or more program modules stored in the memory 520 and to be executed by the one or more processors 510, the one or more program modules include:
an upgrade prompting module 501, adapted to
receive a service request from a third party application requesting a service from the open platform, wherein the service request carries an OAuth credential representing an authorization granted to the third party application by a resource owner;
determine whether the OAuth credential carried in the service request is of an old version OAuth protocol; and
prompt the third party application to perform a version upgrade operation if the OAuth credential carried in the service calling request is of the old version OAuth protocol;
a credential upgrading 502, adapted to
receive a version upgrade request from the third application, wherein the version upgrade request carries an identifier of the third party application, an identifier of the resource owner and the old version OAuth credential;
validate the old version OAuth credential carried in the version upgrade request;
issue a new version OAuth credential to the third party application if the old version OAuth credential is valid; and
return the new version OAuth credential to the third party application.

In this example, the processor 510 may execute the program modules in the memory 520 to further execute all or some of the processes described in the above method examples, which is not repeated herein.

FIG. 6 is a schematic diagram illustrating a structure of a third party application according to an example of the present disclosure. As shown in FIG. 6, the third party application 600 includes:
one or more processors 610;
a memory 620; and
one or more program modules stored in the memory 620 and to be executed by the one or more processors 610, the one or more program modules include:
a service requesting module 601, adapted to
transmit a service request to an open platform requesting a service from the open platform, wherein the service request carries an OAuth credential representing an authorization granted to the third party application by a resource owner; and
an upgrading module 602, adapted to
receive, from the open platform, prompt information indicating that the OAuth credential carried in the service request is of an old version OAuth protocol;
transmit a version upgrading request to the open platform, such that the open platform issues a new version OAuth credential to the third party application; wherein the version upgrade request carries an identifier of the third party application, an identifier of the resource owner and the old version OAuth credential; and
receive the new version OAuth credential issued by the open platform.

In this example, the processor 610 may execute the program modules in the memory 620 to further execute all or some of the processes described in the above method examples, which is not repeated herein.

In view of the above, according to the method and apparatus for upgrading an OAuth credential provided by the examples of the present disclosure, after the OAuth of the open platform is upgraded, the open platform is able to prompt the third party application to start an OAuth upgrade operation when the third party application requests a service from the open platform. The open platform issues a new version OAuth credential to the third party application. Thus, the OAuth credential can be upgraded smoothly and interruption of the service of the third party application is avoided.

The processors 510 and 610 may include one or more processors for executing the sets of instructions stored in the memories 520 and 620. The processors 510 and 610 are hardware devices, such as a central processing unit (CPU) or a micro controlling unit (MCU). The memories 520 and 620 are non-transitory processor-readable storage media, such as a RAM memory, flash memory, ROM memory, EPROM memory, EEPROM memory, registers, hard disk, a removable disk, a CD-ROM, or any other form of non-transitory storage medium known in the art.

What has been described and illustrated herein is a preferred example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for upgrading an open authentication (OAuth) credential, comprising:
receiving, by an open platform, a service request from a third party application requesting a service from the open platform, wherein the service request carries an OAuth credential representing an authorization granted to the third party application by a resource owner;
determining, by the open platform, whether the OAuth credential carried in the service request is of an old version OAuth protocol; prompting, by the open platform, the third party application to perform a version upgrade operation if the OAuth credential carried in the service calling request is of the old version OAuth protocol;
receiving, by the open platform, a version upgrade request from the third application, wherein the version upgrade request carries an identifier of the third party application, an identifier of the resource owner and the old version OAuth credential;
validating, by the open platform, the old version OAuth credential carried in the version upgrade request; issuing, by the open platform, a new version OAuth credential to the third party application if the old version OAuth credential is valid; and
returning, by the open platform, the new version OAuth credential to the third party application.

2. The method of claim 1, further comprising:
after issuing the new version OAuth credential to the third party application, establishing, by the open platform, an association relationship which associates the new version OAuth credential with the identifier of the third party application and the identifier of the resource owner, and saving the association relationship; and
revoking, by the open platform, the old version OAuth credential.

3. The method of claim 1, wherein the old version OAuth credential is an OAuth 1.0 credential, and the new version OAuth credential is an OAuth 2.0 credential.

4. The method of claim 1, wherein the OAuth credential is an OAuth access token.

5. A method for upgrading an open authentication (OAuth) credential, comprising:
transmitting, by a third party application, a service request to an open platform requesting a service from the open platform, wherein the service request carries an OAuth credential representing an authorization granted to the third party application by a resource owner;
receiving, by the third party application, from the open platform prompt information indicating that the OAuth credential carried in the service request is of an old version OAuth protocol;
transmitting, by the third party application, a version upgrading request to the open platform, such that the open platform issues a new version OAuth credential to the third party application; wherein the version upgrade request carries an identifier of the third party application, an identifier of the resource owner and the old version OAuth credential; and
receiving, by the third party application, the new version OAuth credential issued by the open platform.

6. The method of claim 5, further comprising:
after receiving the new version OAuth credential, binding, by the third party application, the new version OAuth credential and the identifier of the resource owner and recording a binding relationship.

7. The method of claim 5, wherein the old version OAuth credential is an OAuth 1.0 credential, and the new version OAuth credential is an OAuth 2.0 credential.

8. The method of claim 5, wherein the OAuth credential is an OAuth access token.

9. A non-transitory computer-readable storage medium comprising a set of instructions for upgrading an open authentication (OAuth) credential, the set of instructions to direct at least one processor to perform acts of:
receiving a service request from a third party application requesting a service from the open platform, wherein the service request carries an OAuth credential representing an authorization granted to the third party application by a resource owner;
determining whether the OAuth credential carried in the service request is of an old version OAuth protocol; prompting, by the open platform, the third party application to perform a version upgrade operation if the OAuth credential carried in the service calling request is of the old version OAuth protocol;
receiving a version upgrade request from the third application, wherein the version upgrade request carries an identifier of the third party application, an identifier of the resource owner and the old version OAuth credential;
validating the old version OAuth credential carried in the version upgrade request; issuing, by the open platform, a new version OAuth credential to the third party application if the old version OAuth credential is valid; and
returning the new version OAuth credential to the third party application.

10. The non-transitory computer-readable storage medium of claim 9, further comprising:
after receiving the new version OAuth credential, binding, by the third party application, the new version OAuth credential and the identifier of the resource owner and recording a binding relationship.

11. The non-transitory computer-readable storage medium of claim 9, wherein the old version OAuth credential is an OAuth 1.0 credential, and the new version OAuth credential is an OAuth 2.0 credential.

12. The non-transitory computer-readable storage medium of claim 9, wherein the OAuth credential is an OAuth access token.
